(19) United States
(12) Patent Application Publication
(10) Pub. No.: US 2025/0106511 A1
(43) Pub. Date: Mar. 27, 2025

(54) IMAGING SYSTEM AND MOBILE OBJECT HAVING SAME

(71) Applicant: Panasonic Intellectual Property Management Co., Ltd., Osaka (JP)

(72) Inventors: Satoshi MATSUI, Kyoto (JP); Norikazu Katsuyama, Osaka (JP)

(21) Appl. No.: 18/977,235

(22) Filed: Dec. 11, 2024

Related U.S. Application Data
(63) Continuation of application No. PCT/JP2023/022059, filed on Jun. 14, 2023.

(30) Foreign Application Priority Data
Jun. 16, 2022 (JP) 2022-097549

(51) Int. Cl. H04N 23/68; G03B 17/17

(52) U.S. Cl. CPC H04N 23/685; G03B 17/17; H04N 23/6812

(57) ABSTRACT

An imaging system includes an imaging device, a blur correction assembly that corrects a blur along a moving direction in a captured image, and a controller that controls an imaging timing of the imaging device. The blur correction assembly drives a blur corrector to make a blur correction along the moving direction. The blur corrector has a drive range including a reference position where an axis perpendicular to an imaging target surface is parallel to an optical axis of the imaging device, the optical axis being an axis of light injecting to the blur corrector from the imaging target surface. The controller causes the imaging device to start imaging when the blur corrector is located within a range where a difference from the reference position is less than or equal to a threshold during driving of the blur corrector.

### CROSS-REFERENCE TO RELATED APPLICATIONS

This is a continuation application of International Application No. PCT/JP2023/022059, with an international filing date of Jun. 14, 2023, which claims priority of Japanese Patent Application No. 2022-097549 filed on Jun. 16, 2022, the content of which is incorporated herein by reference.

### BACKGROUND

### Technical Field

The present disclosure relates to an imaging system that corrects a blur in accordance with a movement of a mobile object, and a mobile object having the imaging system.

### Background Art

With the aging of transportation infrastructure, the demand for infrastructure inspection is increasing. The inspection efficiency is remarkably improved by imaging the infrastructure facility during movement with a mobile object and detecting a defective portion on the captured image with image processing instead of the visual inspection by a person. However, since imaging is performed during moving, a blur occurs in a captured image.

For example, in WO 2015/060181 A, a blur due to camera movement during exposure is corrected using a technique of a saccade mirror. The blur is reduced by irradiating an imaging target with light, by reflecting the light reflected from the imaging target from a mirror, and by injecting the light to the camera. The mirror rotates for a predetermined exposure time.

### SUMMARY

However, if an imaging frame interval is fixed, imaging is performed at a rotation position of a mirror, the rotation position varying depending on a moving speed of the mobile object. As a result, a subject distance with respect to an imaging target surface varies, and thus the accuracy of a blur correction might be degraded.

The present disclosure provides an imaging system in which degradation in the accuracy of the blur correction is suppressed, and a mobile object including the imaging system.

An imaging system of the present disclosure includes an imaging device disposed in a mobile object, a blur correction assembly that corrects, based on a blur correction amount, a blur in a moving direction where the mobile object moves at a time when the imaging device performs imaging while the mobile object is moving, and a controller that controls an imaging timing of the imaging device. The blur correction assembly drives a blur corrector to correct a blur in the moving direction. The blur corrector has a reference position where an axis perpendicular to an imaging target surface is parallel to an optical axis of light injected to the blur corrector. The controller causes the imaging device to start imaging in synchronization with a time when the blur corrector is located within a range where the amount of displacement from the reference position is less than or equal to a threshold during driving of the blur corrector.

Further, the mobile object of the present disclosure includes the above-described imaging system.

According to the imaging system and the mobile object having the same of the present disclosure, it is possible to provide the imaging system in which the degradation in the accuracy of the blur correction is suppressed and the mobile object having the same.

### BRIEF DESCRIPTION OF DRAWINGS

FIG. 1 is a diagram for explaining a vehicle including an imaging system according to a first embodiment.

FIG. 2 is a block diagram illustrating an internal configuration of the imaging system according to the first embodiment.

FIG. 3 is an explanatory diagram for explaining a blur correction of the imaging system.

FIG. 4 is an explanatory diagram for explaining an imaging device at an ideal imaging timing.

FIG. 5 is a flowchart illustrating imaging processing in the first embodiment.

FIG. 6A-6C are graphs illustrating a relationship between an exposure timing and a mechanism swing angle in the first embodiment.

FIG. 7 is an explanatory diagram illustrating a mirror in respective states of mechanism swing angle.

FIG. 8 is an explanatory diagram illustrating images captured in a case of continuous imaging.

FIG. 9 is a block diagram illustrating an internal configuration of an imaging system according to a second embodiment.

FIG. 10 is an explanatory diagram for explaining the imaging system at a time when an attitude changes in a vehicle.

FIG. 11 is a flowchart illustrating imaging processing in the second embodiment.

FIG. 12A-12E are graphs illustrating a relationship between an exposure timing and a mechanism swing angle in the second embodiment.

FIG. 13 is an overall perspective view illustrating the rotatable imaging device.

### DETAILED DESCRIPTION

### First Embodiment

A first embodiment will be described below with reference to the drawings. The first embodiment describes a case where the mobile object is a vehicle 3 such as an automobile and an imaging system 1 is attached to an upper portion of the vehicle 3 as an example.

### [1. Configuration of Imaging System]

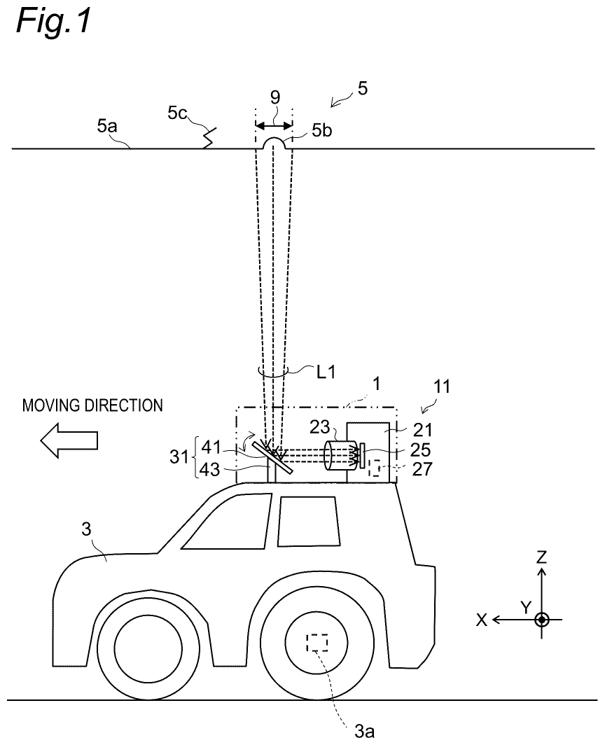

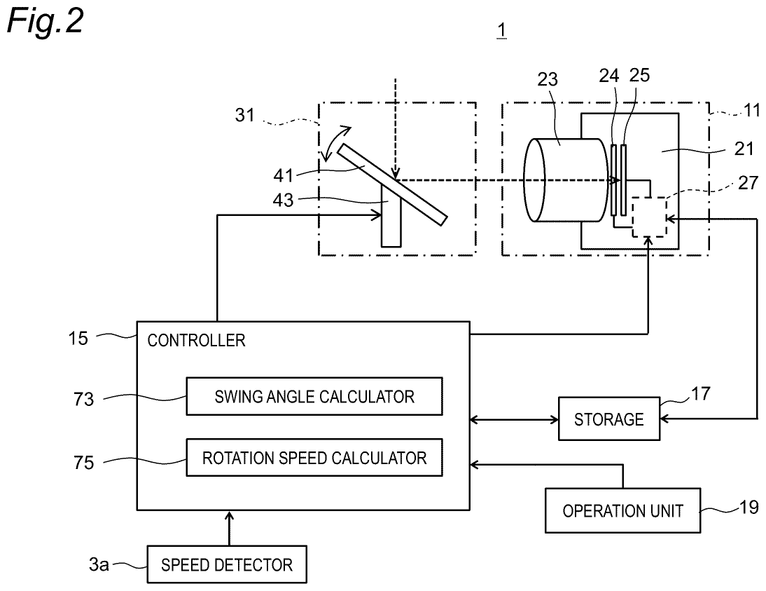

FIG. 1 is a diagram for explaining the imaging system 1. FIG. 2 is a block diagram illustrating an internal configuration of the imaging system 1. In FIG. 1, the vehicle 3 is traveling in a tunnel 5, for example. For example, a hole 5b or a crack 5c occurs on a wall surface 5a in the tunnel 5.

An imaging target of the imaging system 1 is at least a part of a structure around the vehicle 3, and is a target that relatively moves in accordance with a moving speed of the vehicle 3 when the vehicle 3 moves. An imaging target region 9 is a region acquired as an image in the imaging target. The imaging target may include, in addition to the inner wall of the tunnel 5, a side surface and a bottom surface of bridge, a utility pole, and an electric wire. This makes it possible to detect, in the acquired image, a hole, a crack, lifting, peeling, and a joint of the imaging target, an inclination of a utility pole, and deflection of an electric wire with the image processing.

A speed detector 3a that detects the moving speed of the vehicle 3 is disposed in the vehicle 3. The speed detector 3a is, for example, a vehicle speed sensor that detects the moving speed based on a rotation speed of an axle of the vehicle 3. A receiver of a global positioning system (GPS) is further disposed in the vehicle 3.

The imaging system 1 is installed on an upper surface of the vehicle 3. The imaging system 1 is fixed to capture an image of the wall surface 5a of the tunnel 5 above the vehicle 3 in FIG. 1. However, the imaging system 1 may be installed to capture an image of the wall surface 5a being lateral to or obliquely lateral to the vehicle 3, or a road surface below the vehicle 3.

The imaging system 1 includes an imaging device 11, a blur correction assembly 31, a controller 15, a storage 17, an operation unit 19, and a speed detector 3a. The imaging device 11 captures an image of a periphery of the vehicle 3, and images the wall surface 5a of the tunnel 5 in a case, for example, where the vehicle 3 travels in the tunnel 5. The imaging device 11 includes a camera body 21, a lens 23, a shutter 24, an imaging element 25, and a camera controller 27.

The lens 23 is attached to the camera body 21 to be replaceable. The camera body 21 accommodates the imaging element 25 and the camera controller 27. The imaging element 25 is disposed at a position of a focal length F of the lens 23. The camera body 21 is disposed in the vehicle 3 so that the direction of the lens 23 is parallel to the moving direction of the vehicle 3. For example, the camera body 21 is disposed so that the lens 23 faces forward or backward of the vehicle 3. The camera body 21 and the lens 23 may be integrated, and in this case, the orientation and the moving direction of the lens 23 may be installed to be vertical. The camera controller 27 opens the shutter 24 while receiving an exposure instruction signal from the controller 15. The shutter 24 may be configured to open and close a plurality of blade diaphragms, or may be an electronic shutter. The imaging element 25 converts received light into an electric signal depending on intensity. The imaging element is a solid-state imaging element, such as a charge-coupled device (CCD) image sensor, a complementary metal oxide semiconductor (CMOS) image sensor, or an infrared image sensor.

The blur correction assembly 31 corrects an optical path of light injected to the imaging system 1 to reduce the blur in the image of the imaging target region 9 even if the imaging device 11 performs imaging while the vehicle 3 is moving.

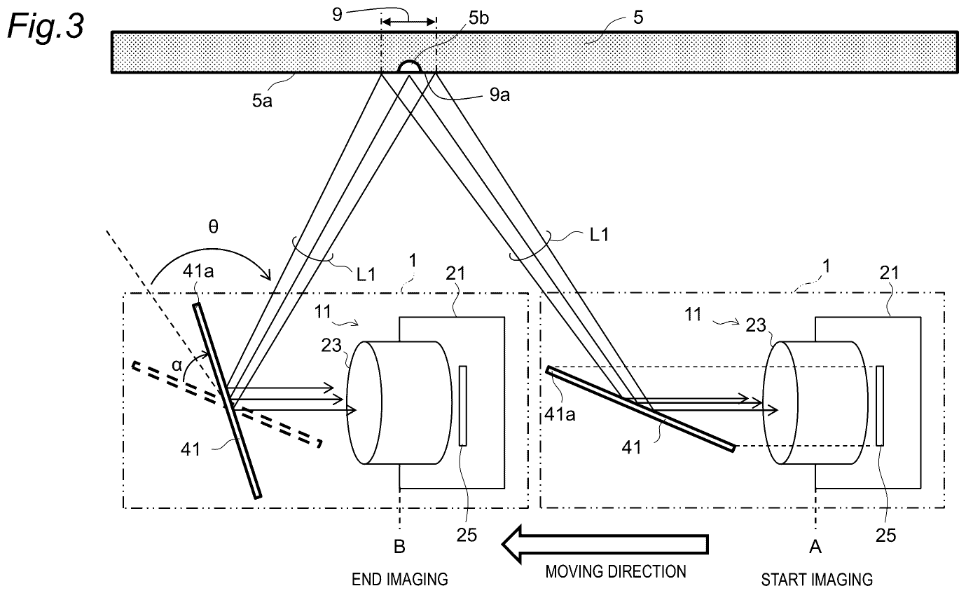

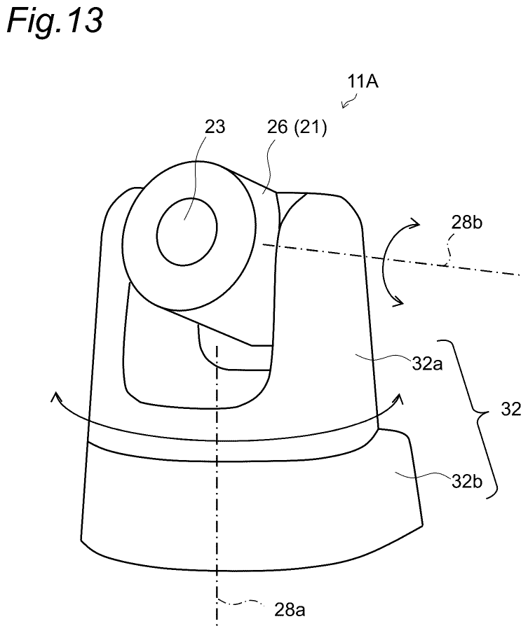

The blur correction assembly 31 corrects the optical path of light L1, which is the ambient light reflected by the imaging target region 9, in accordance with the movement of the vehicle 3. The blur correction assembly 31 matches the direction of the light L1, which is the ambient light reflected by the imaging target region 9, with the imaging direction of the imaging element 25. The blur correction assembly 31 includes, for example, a mirror 41 as a blur corrector, and a mirror drive 43. The mirror 41 as the blur corrector is rotated in accordance with the movement of vehicle 3 while facing the imaging target surface 9a (see FIG. 3). Note that the blur correction assembly 31 is not limited thereto, and as illustrated in FIG. 13, may include an imaging device drive assembly 32. The imaging device drive assembly 32 drives to rotate an imaging device 11A about two rotation axes, for example, in a pan direction and a tilt direction. The imaging device 11A includes a lens barrel 26 (camera body 21) in which the lens 23 and the imaging element 25 are integrated. The imaging device drive assembly 32 includes, for example, an arm 32a and a base 32b. The arm 32a rotatably supports the lens barrel 26 in the tilt direction which is a vertical direction. The base 32b rotatably supports the arm 32a in the pan direction which is a lateral direction. The arm 32a and the base 32b include a motor and a gear as drive assembly. The imaging device 11A that also functions as the blur corrector is rotated in accordance with the movement of the vehicle 3 with the lens 23 facing the imaging target surface 9a. Similarly to the imaging device 11, the imaging device 11A includes the shutter 24, the imaging element 25, and the camera controller 27. The controller 15 controls a driving direction and a driving amount of the imaging device drive assembly 32. Further, the blur correction assembly 31 may include an assembly that translationally drives the entire imaging device 11 with respect to the imaging target region 9.

The mirror 41 is rotatably disposed to face the lens 23. For example, the mirror 41 is rotatable in both a clockwise, i.e. normal direction and a reverse direction, and the rotatable angular range may be less than 360 degrees or 360 degrees or more. The mirror 41 totally reflects the light, which is the ambient light reflected by the imaging subject, toward imaging device 11. The mirror drive 43 rotationally drives the mirror 41 from an initial angle as a rotation start position to an instructed angle, and returns the mirror 41 to the initial angle again after rotating the mirror to the instructed angle. The initial angle varies depending on the moving speed. The mirror drive 43 is, for example, a motor.

The rotation angle of the mirror 41 is limited by the mechanical restriction of the mirror drive 43. The mirror 41 can be rotated to a maximum swing angle of the mirror 41 determined by this restriction.

With reference to FIG. 3, the blur correction made by the blur correction assembly 31 will be described. FIG. 3 is an explanatory diagram for explaining a blur correction of the imaging system 1. For example, it is assumed that the imaging system 1 located at a position A moves to a position B during the exposure time together with the vehicle 3. In the image started to be captured at the position A and acquired at this timing, for example, the hole 5b of the imaging target region 9 is imaged. However, due to insufficient exposure time, the image is dark and unclear.

Therefore, the exposure is continued until the vehicle 3 moves to the position B. In this case, if no blur correction is made, the imaging target region 9 relatively moves in the direction opposite to the moving direction of the vehicle 3, thereby obtaining the image in which the hole 5b is relatively moved. In the image in which the exposure is continued, the movement amount of pixels is detected as the blur amount. As described above, the image captured by the imaging device 11 while the vehicle 3 is moving becomes a blurred image.

Therefore, in accordance with the moving speeds of the imaging system 1 and the vehicle 3, the mirror 41 is rotated in the direction where an end 41a of the mirror 41 on the moving direction side offsets the relative movement of the imaging target during the exposure time. This enables the imaging system 1 to image the same imaging target region 9 in the captured image during the exposure time, and to acquire an image in which the blur is greatly reduced. In FIG. 3, the mirror 41 is rotated clockwise through a blur correction swing angle α so that the end 41a of the mirror 41 on the moving direction side turns toward the imaging target side during the exposure time. By rotating the mirror 41 through the blur correction swing angle α, the movement amount of the pixel in the captured image is corrected to 0.

The focal length F is a value determined by the lens 23. The subject magnification M is a value determined by the focal length F and the subject distance. The subject distance is a distance from the principal point of the lens 23 to an imaging target, which is a subject. The lens 23 is disposed between the imaging target and the imaging element 25. As the subject distance, a known value measured in advance may be used, or a value measured by a distance meter during imaging may be used.

As illustrated in FIG. 2, the controller 15 includes a swing angle calculator 73 and a rotation speed calculator 75. The swing angle calculator 73 calculates a blur correction swing angle of the mirror 41 as the blur corrector. The mirror 41 is rotated through the blur correction swing angle for a blur correction during imaging. The rotation speed calculator 75 calculates a rotation speed Vm of the mirror 41 based on the blur correction swing angle calculated by the swing angle calculator 73 and the exposure time.

The controller 15 controls the blur correction operation of the blur correction assembly 31 based on the rotation speed of the mirror 41 calculated by the rotation speed calculator 75 and the exposure time. Further, the controller 15 controls the imaging timing of the imaging device 11, and causes the imaging device 11 to start imaging in synchronization with a time when the mirror 41 is located within a range in which the amount of displacement from the reference position is smaller than or equal to a threshold during the blur correction operation by the blur correction assembly 31.

In the controller 15, the controller that controls the blur correction assembly 31 and the controller that controls the imaging timing of the imaging device 11 may be configured separately.

The swing angle calculator 73 calculates the blur correction swing angle α of the mirror 41 during imaging in the following flow based on the moving speed V of the vehicle 3, a set exposure time Tp, a subject magnification M, and the focal length F of the lens 23. Note that the exposure time Tp may be manually set by the user through the operation unit 19, or may be automatically set by the controller 15 in accordance with the brightness of a surrounding environment of the imaging target.

A movement amount L of the vehicle 3 that has moved during an exposure start time t1 to an imaging end time t2 is calculated based on the moving speed V and the exposure time Tp according to the following Equation (1).

$$L [ mm ] = V [ km / h ] \times {10}^{6} \times Tp [ ms ] / ( {60}^{2} \times {10}^{3} ) \qquad Equation ( 1 )$$

Each movement amount P of the pixel on the imaging element 25 from the imaging start times t1, t3, and t5 to the imaging end times t2, t4, and t6 is calculated based on the movement amount L of the vehicle 3 and the subject magnification M according to the following Equation (2).

$$P [ mm ] = L [ mm ] \times M \qquad Equation ( 2 )$$

The movement amount P of the pixel causes a blur. Therefore, the optical path of the light projected to the lens 23 is changed by a blur correction angle θ depending on the movement amount P of the pixel so that a blur does not occur. The blur correction angle θ is calculated based on the movement amount P of the pixel and the focal length F according to the following Equation (3).

$$θ [ deg ] = arc tan ( P / F ) \qquad Equation ( 3 )$$

As described above, the subject magnification M is calculated based on the focal length F [mm] and the subject distance D [m] according to the following Equation (4).

$$M = F / ( D \times {10}^{3} ) \qquad Equation ( 4 )$$

According to Equations (1), (2), (3), and (4),

$$\begin{matrix}θ = arc tan ( V \times {10}^{6} \times Tp / ( {60}^{2} \times {10}^{3} ) / ( D \times {10}^{3} ) ) \\ = arc tan ( V \times Tp / ( D \times {60}^{2} ) )\end{matrix} \qquad Equation ( 5 )$$

In such a manner, the blur correction angle θ is calculated based on the moving speed V, the exposure time Tp, and the subject distance D.

Since the blur correction swing angle α necessary for a blur correction during exposure is half the blur correction angle θ, the blur correction swing angle α is calculated according to the following Equation (6).

$$α = θ / k \qquad Equation ( 6 )$$

Here, k represents a coefficient of conversion between the mirror swing angle α as a mechanism swing angle of the drive assembly and the blur correction angle θ as an optical correction angle at which light incident to the lens 23 is corrected. In a case of the configuration in which light from an imaging target travels through the mirror 41, the lens 23, and the imaging element 25 in this order as in the embodiment of FIG. 1, the conversion coefficient k is 2. Further, in a case of a pan-tilt mechanism in which the imaging device 11 and the blur correction assembly 31 are integrated or a configuration of overall camera drive, the conversion coefficient k is 1.

In such a manner, the swing angle calculator 73 calculates the blur correction swing angle α of the mirror 41.

The rotation speed calculator 75 calculates the rotation speed Vm of the mirror 41 based on the blur correction swing angle α and the exposure time Tp according to the following Equation (7).

$$Vm = α / Tp \qquad Equation ( 7 )$$

Therefore, by rotating the mirror 41 in a direction opposite to the moving direction at the rotation speed Vm after the start of imaging, the imaging device 11 can receive the light L1 from the same imaging target region 9 during the exposure time, and can suppress the occurrence of a blur in the captured image.

The storage 17 is a storage medium that stores programs and data necessary for implementing the functions of the controller 15. The storage 17 can be implemented by, for example, a hard disk (HDD), a solid-state disk (SSD), a random access memory (RAM), a dynamic random access memory (DRAM), a ferroelectric memory, a flash memory, a magnetic disk, or a combination thereof.

The operation unit 19 is an input device for the user to instruct the controller 15. The operation unit 19 may be an input device such as a keypad or touch panel dedicated to the imaging system 1 or a mobile terminal such as a smartphone. In a case where a mobile terminal is used as the operation unit 19, the operation unit 19 and the controller 15 transmit and receive data via wireless communication. The user may use the operation unit 19 to issue an instruction to determine whether the imaging target region is an indoor dark region, such as a tunnel, or an outdoor bright region such as a slope of a mountain.

Next, problems of the present disclosure will be described in detail. As described above, since the imaging is performed while the mirror 41 is being rotated, the subject distance of the light L1 from the imaging target region 9 changes depending on the angle of the mirror 41 with respect to the imaging target. For example, in a case where imaging is started at the position A in FIG. 3, a reflection surface of the mirror 41 is not inclined at 45 degrees with respect to an imaging plane (the imaging element 25 of the camera body 21) and the imaging target surface 9a. Thus, the respective subject distances in the light L1 are not uniform, and the accuracy of the blur correction is degraded. Conventionally, exposure is performed at fixed moving distance intervals in synchronization with acquisition of a vehicle speed pulse signal, or exposure is performed at set time intervals with an imaging frame cycle being determined in advance.

Therefore, depending on the position of the blur correction assembly during the exposure, there is a case where an axis perpendicular to the imaging target surface is not parallel to the optical path from the imaging target region 9 to the mirror 41, and variation occurs in each subject distance in the imaging plane. When the subject distances in the imaging plane vary, the blur correction accuracy is degraded. In particular, in a case where the axis perpendicular to the imaging target surface does not become parallel to the optical path from the imaging target region 9 to the mirror 41 even once during the exposure time, the accuracy of the blur correction is degraded.

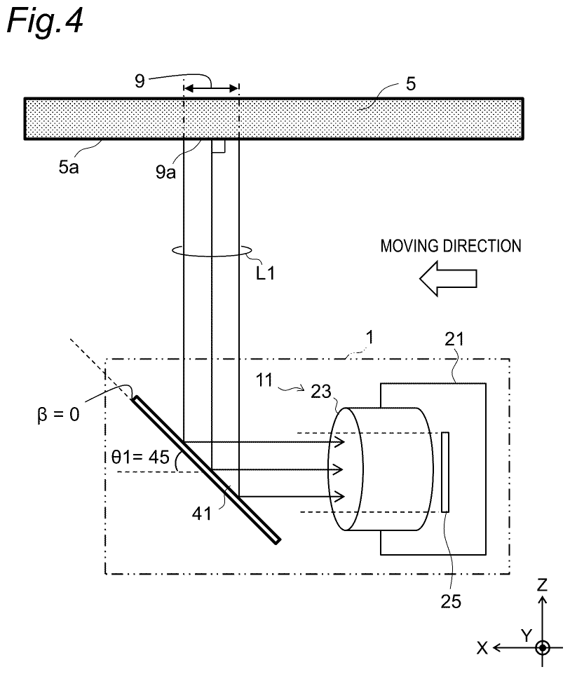

As illustrated in FIG. 4, when the imaging plane is perpendicular to the imaging target surface and a first mechanism swing angle θ1, which is the swing angle of the mirror 41 with respect to the horizontal direction, is 45 degrees, the axis perpendicular to the imaging target surface 9a of the imaging target region 9 is parallel to the optical path from the imaging target region 9 to the mirror 41. Therefore, imaging is performed at the rotation position of the mirror 41 such that the axis perpendicular to the imaging target surface 9a of the imaging target region 9 is parallel to the optical path from the imaging target region 9 to the mirror 41. As a result, the respective subject distances in the imaging plane of the imaging element 25 become uniform, and the accuracy of the blur correction for setting the blur correction amount depending on the subject distance is improved. Actually, imaging is performed within a predetermined angle range including a rotation position of mirror 41 such that the axis perpendicular to the imaging target surface 9a of imaging target region 9 is parallel to the optical path from imaging target region 9 to mirror 41. To achieve this, exposure is performed in synchronization with the rotation of the mirror 41 of the blur correction assembly through the blur correction swing angle α.

### [1-2. Operation of Imaging System]

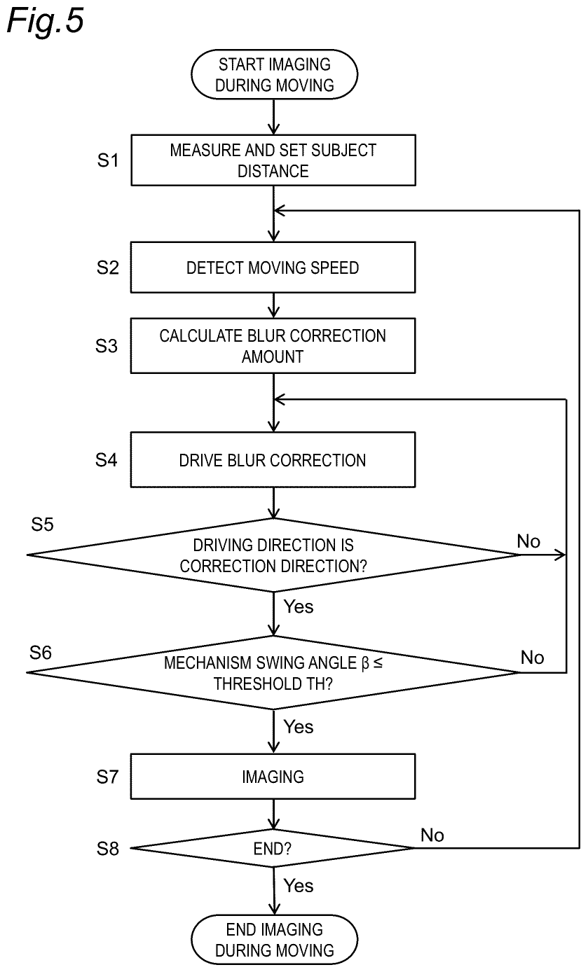

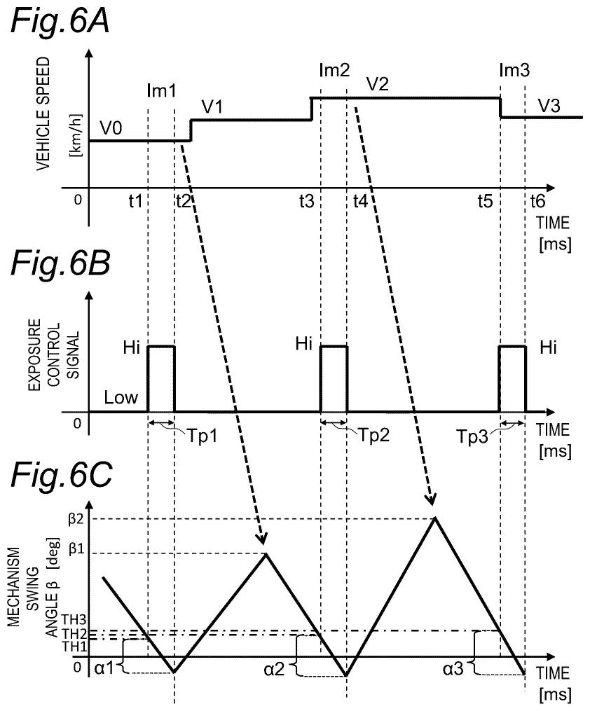

The operation of the imaging system 1 will be described below with reference to FIGS. 5 and 6. FIG. 5 is a flowchart illustrating imaging processing performed by the imaging system 1. FIG. 6A-6C are graphs illustrating a relationship between a second mechanism swing angle β of the blur correction assembly and exposure. FIG. 6A is the graph illustrating the moving speed of the vehicle 3. The moving speed changes with the lapse of time. FIG. 6B is the graph illustrating the timing of the exposure time. FIG. 6C is the graph illustrating variations in the second mechanism swing angle β of the blur correction assembly. The imaging processing illustrated in FIG. 5 is started, for example, when the instruction to start imaging is issued from the operation unit 19 while the vehicle 3 is moving.

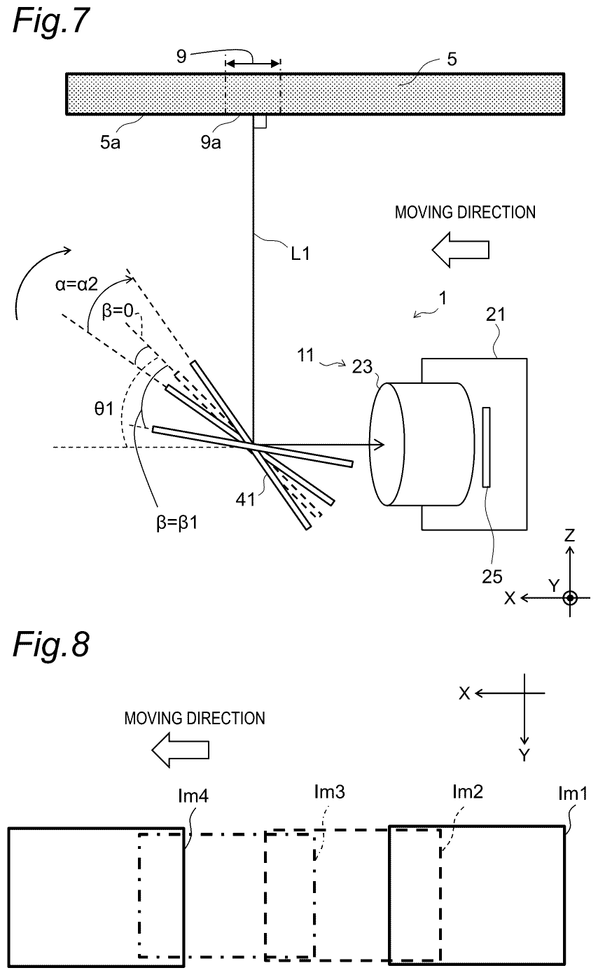

Here, in a state where the attitude state of the vehicle 3 is kept horizontal and the first mechanism swing angle θ1 of the mirror 41 with respect to the horizontal direction is 45 degrees, the second mechanism swing angle β of the mirror 41 is 0 degrees, and this state is regarded as the reference position of the blur correction assembly 31 (see FIG. 4). The second mechanism swing angle β indicates a displacement angle (displacement amount) of the mirror 41 with respect to the reference position. The reference position is, for example, a position where the angle of the mirror 41 with respect to the horizontal direction is 45 degrees (first mechanism swing angle θ1=45). For example, the second mechanism swing angle β has a positive sign in the rotation direction from the reference position to the traveling direction of the vehicle 3 and a negative sign in the rotation direction in the direction opposite to the traveling direction, but may be designed by reversing the positive and negative signs (see FIGS. 4 and 7).

FIG. 5 is referred to. In step S1, a user measures in advance a subject distance from the imaging element 25 of the camera body 21 to the wall surface 5a of the tunnel 5 as the imaging target, and sets the measured subject distance for the controller 15 using the operation unit 19. Further, by setting the section of the road to be imaged, for example, the controller 15 can determine whether the vehicle has traveled on the road in the set section, based on acquired global positioning system (GPS) information and traveling distance. Note that the first image Im1 has already been captured, and the flow of imaging at the following steps after the second image Im2 will be described.

In step S2, the speed detector 3a detects the moving speed V0 of the vehicle 3 that is traveling. The detected moving speed is sent to the controller 15. FIG. 6A illustrates a change in the moving speed of the vehicle 3. The moving speed of the vehicle 3 increases from the moving speed V0 at the time of capturing the first image Im1 to a moving speed V1 before the second image Im2 is captured. The moving speed further increases to a moving speed V2 at the time of capturing the second image Im2, and decreases to a moving speed V3 at a time of capturing a third image Im3.

In step S3, the swing angle calculator 73 calculates a blur correction swing angle α2 as the blur correction amount based on the moving speed V0 and an exposure time Tp2 of the image Im2 to be captured next according to the above-described Equations (1) to (6). Here, Tp2=t4−t3. Note that the exposure times Tp1, Tp2, and Tp3 of the images Im1 to Im3 may be the same time, or may be changed depending on the illuminance of the ambient light. The rotation speed calculator 75 calculates a rotation speed Vm2 of the mirror 41 based on the blur correction swing angle α2. Further, the swing angle calculator 73 calculates a rotation start position β1. In a case where imaging is performed in synchronization with a vehicle speed pulse signal, the time interval (imaging interval) until the next imaging can be estimated based on the moving speed V0 of the vehicle 3 used to calculate the blur correction angle θ. In a case where imaging is performed at a fixed frame rate, the time interval can be estimated based on the frame rate. It is necessary to perform the rotation in the correction direction and the rotation in the opposite direction for securing the range of rotation in the correction direction for securing the responsiveness of the blur correction assembly respectively within the estimated time intervals. The rotation speed in the correction direction and the rotation speed in the direction opposite to the correction direction may be different speeds, or may be the same rotation speed for simplification. In the case of the same rotation speed, the rotation speed Vm×half of the estimation time=β1.

In step S4, as illustrated in FIG. 6C and FIG. 7, the controller 15 rotates the mirror 41 in the direction opposite to the correction direction to displace the mirror 41 to the rotation start position 1 in the correction direction of the calculated swing angle α2. The drive cycle of the mirror 41 is between the timing when the exposure ends to the timing when the exposure of a next image ends. A direction where the mirror 41 is rotated in the correction direction is defined as a positive direction. When the mirror 41 reaches the rotation start position β1 in the correction direction, the controller 15 causes the mirror drive 43 to rotate the mirror 41 at the calculated rotation speed Vm2. As a result, the mirror 41 starts to rotate from the rotation start position 31 in the correction direction of the second mechanism swing angle β greater than the calculated mirror swing angle α2. In this manner, the blur correction of the imaging device 11 is made.

In step S5, the controller 15 determines whether the driving direction of the blur correction assembly 31 is the correction direction. Here, the correction direction is a direction where the mirror 41 is rotated for the blur correction. When determining that the driving direction of the blur correction assembly 31 is not the correction direction (No in step S5), the controller 15 regards that the mirror 41 is rotating in the direction opposite to the correction direction toward the rotation start position, and continues step S4.

When determining that the driving direction of the blur correction assembly 31 is the correction direction (Yes in step S5), the controller 15 determines whether the second mechanism swing angle β of the mirror 41 is smaller than or equal to a threshold TH (TH=TH2). The threshold TH is greater than 0 degrees. The threshold TH is a value indicating a predetermined range where imaging is possible at the reference position. The threshold TH is determined based on the blur correction swing angle α of the imaging device 11. For example, in order that the center of the exposure time is set when the blur corrector is at the origin (mechanism angle 0), the exposure may be started when the blur corrector is located on the positive side in FIG. 6 by half the blur correction amount. Thus, the threshold TH is half the blur correction amount. That is, since the blur correction amount changes at each imaging, the threshold TH is determined based on the blur correction amount. Since the blur correction amount is calculated based on the moving speed, the exposure time, and the subject distance, the threshold TH is also determined based on the moving speed, the exposure time, and the subject distance. The threshold TH may be changed depending on the moving speed of the vehicle 3. The controller 15 may increase the threshold TH as the moving speed of the vehicle 3 becomes higher, and decrease the threshold TH as the moving speed becomes lower. FIG. 6C illustrates three thresholds TH1, TH2, and TH3 as the threshold TH. The threshold TH1 is a threshold corresponding to the moving speed used for capturing the first image Im1. The threshold TH2 is a threshold corresponding to the moving speed V0 used for capturing the second image Im2. The threshold TH3 is a threshold corresponding to the moving speed V2 used for capturing the third image Im3. As the moving speed (vehicle speed) increases, the value increases from the threshold TH1 toward the threshold TH3.

When determining that the second mechanism swing angle β of the mirror 41 is not smaller than or equal to the threshold TH2 (No in step S6), the controller 15 regards that the second mechanism swing angle β of the mirror 41 has not reached near 0 degrees (reference position), and continues steps S4 and S5.

When determining that the second mechanism swing angle β of the mirror 41 is small than or equal to the threshold TH2 (Yes in step S6), the controller 15 regards that the second mechanism swing angle β of the mirror 41 has reached near 0 degrees, and continues sending a Hi signal instructing exposure to the camera controller 27 as the exposure control signal during the exposure time Tp in step S7. This makes it possible to perform imaging when the second mechanism swing angle β of the mirror 41 is within the range of the blur correction swing angle α2 including 0 degrees. By determining the exposure timing based on the threshold TH, the exposure can be started before the mirror 41 reaches the reference position, and the position of the mirror 41 at the center of the exposure time can be brought close to the reference position.

In the imaging device 11, the camera controller 27 acquires an image by opening the shutter 24 to perform exposure while receiving the Hi signal, and stores the acquired image in the storage 17. When the exposure time Tp2 has elapsed, the controller 15 continues sending, to the camera controller 27, a Low signal as an OFF signal instructing to stop exposure. The camera controller 27 closes the shutter 24 while receiving the Low signal. Note that a Low signal may be used as an ON signal instructing exposure, and a Hi signal may be used as an OFF signal instructing to stop exposure.

In step S8, the controller 15 determines whether the vehicle 3 has finished traveling in the predetermined section. When the controller 15 determines that the vehicle 3 has finished traveling in the predetermined section, the image acquisition of the road in this section ends. The controller 15 thus ends the imaging during moving. When determining that the vehicle 3 has not finished traveling in the predetermined section, the controller 15 returns to step S2 to perform the imaging during moving again.

The flow of capturing the first image Im1 through the third image Im3 including the operation of the imaging system 1 in a case where images are consecutively captured, thus, after returning to step S2 will be further described with reference to FIGS. 6 and 8. As illustrated in FIG. 8, in the consecutive imaging mode, when the second image Im2 is captured, the image is captured so that an end region on the opposite side to the moving direction in the captured second image Im2 overlaps with an end region in the moving direction in the captured first image Im1. Further, when the third image Im3 is captured, the image is captured so that an end region on the side opposite to the moving direction in the captured third image Im3 overlaps with an end region in the moving direction in the captured second image Im2. Similarly, by consecutively capturing a fourth image and subsequent images, captured images can be acquired consecutively in a line. In FIG. 8, the widths of the images Im1 to Im4 in the Y-axis direction are different for easy understanding, but the actual widths are the same.

The first image Im1 is captured at the blur correction swing angle α1. The blur correction swing angle α2 and the rotation speed Vm2 of the second image Im2 are calculated based on the moving speed V0 of the vehicle 3 at the time of capturing the first image Im1. After the capturing of the first image Im1 is completed, the mirror drive 43 rotates the mirror 41 in the direction opposite to the correction direction toward the rotation start position β1. The rotation speed of the mirror 41 in the opposite direction after the end of the exposure may be the same as or different from the rotation speed in the normal direction. In a case where the rotation speed is the same in the normal direction and the opposite direction, the mirror drive 43 rotates the mirror 41 in the opposite direction at the rotation speed Vm2 after the exposure of the first image Im1 ends. When the mirror 41 reaches the rotation start position 1 in the correction direction, the mirror drive 43 rotates the mirror 41 in the normal direction at the rotation speed Vm2. When the second mechanism swing angle β of the mirror 41 is the threshold TH2 or smaller, the controller 15 instructs exposure, the shutter 24 is opened, and the second image Im2 is captured at the blur correction swing angle α2. Here, the threshold TH2 may be, for example, a value within a range of TH2≤α2.

A blur correction swing angle α3 of the third image Im3 is calculated based on the moving speed V2 of the vehicle 3 at the time of capturing the second image Im2. After the capturing of the second image Im2 is completed, the mirror drive 43 rotates the mirror 41 in the direction opposite to the correction direction toward a rotation start position β2. When the mirror 41 reaches the rotation start position β2, the mirror drive 43 rotates the mirror 41 in the normal direction at a calculated rotation speed Vm3. When the second mechanism swing angle β of the mirror 41 is the threshold TH3 or smaller, the controller 15 instructs exposure, the shutter 24 is opened, and the third image Im3 is captured.

In this manner, the blur correction swing angle α2, the rotation speed Vm2, and the rotation start position 31 in the correction direction at the time of exposure of the second image Im2 are determined based on the moving speed V0 of the vehicle 3 at the time of exposure of the first image Im1. The exposure can be performed at the optimum timing synchronized with the blur correction by continuing the exposure of the second image Im2 when the mirror 41 is located at the reference position and positions before and after the reference position.

### [1-3. Effects, Etc.]

The imaging system 1 includes the imaging device 11 disposed in the vehicle 3, the blur correction assembly 31, and the controller 15. The blur correction assembly 31 corrects, based on the blur correction swing angle α, a blur in the moving direction where the vehicle 3 moves at the time when the imaging device 11 performs imaging while the vehicle 3 is moving. The controller 15 controls the imaging timing of the imaging device 11. The blur correction assembly 31 drives the mirror 41 to make the blur correction in the moving direction. The mirror 41 has the reference position where the axis perpendicular to the imaging target surface 9a is parallel to the optical axis of the light L1 injected to the mirror 41. The controller 15 causes the imaging device 11 to start imaging in synchronization with a time when the mirror 41 is located within a range where the amount of displacement from the reference position is less than or equal to the threshold TH during driving of the mirror 41.

As a result, the imaging device 11 can reliably perform imaging when the mirror 41 is located at the reference position. Therefore, the variations in the subject distance in the imaging plane is reduced, and the accuracy of the blur correction is improved. The blur correction is for setting the blur correction swing angle α as the blur correction amount depending on the subject distance.

The mirror 41 is driven by an amount greater than the blur correction swing angle α for making the blur correction in the moving direction. Thus, the mirror 41 is driven by the amount greater than the blur correction swing angle α, thereby securing the driving responsiveness necessary for the blur correction in the moving direction. Further, it is easy to take the timing of causing the imaging device 11 to start imaging.

The controller 15 updates the threshold TH based on the blur correction swing angle α of the imaging device 11. This makes it possible to set the threshold TH with high accuracy for the blur correction.

The controller 15 may cause the imaging device 11 to start imaging when the mirror 41 is located at the reference position or before the mirror 41 reaches the reference position, and may end the imaging after the mirror 41 passes through the reference position. As a result, since the mirror 41 passes through the reference position while the imaging device 11 is performing imaging, the subject distances in the imaging plane become uniform. Thus, the accuracy of the blur correction for setting the blur correction swing angle α as the blur correction amount depending on the subject distance is improved. Therefore, an image with reduced blur can be acquired.

The blur correction assembly 31 rotates the mirror 41 in the correction direction to make the blur correction in the moving direction, and reverses the driving direction of the mirror 41 in the direction opposite to the correction direction based on the imaging end timing. In a case of a configuration where the blur correction assembly 31 does not rotate the mirror 41 in the direction opposite to the correction direction, the 360-degree rotation control is performed. Therefore, a drive range of the mirror 41 is widened, and a control resolution (angle command accuracy) is degraded. By rotating the mirror 41 in the direction opposite to the correction direction, for example, the mirror 41 may be rotated within a range of ±10 degrees or less, and thus the rotation accuracy can be heightened.

The blur correction assembly 31 rotates the mirror 41 in the correction direction for making the blur correction in the moving direction. The blur correction amount is the blur correction swing angle α through which the mirror 41 is rotated in the correction direction. The blur correction swing angle α corresponds to the movement amount P of the pixel on the imaging element of the imaging device 11 due to the movement of the vehicle 3. Since the blur correction swing angle α corresponds to the movement amount P of the pixel, the blur in the captured image can be reduced.

The blur correction assembly 31 rotates the mirror 41 in the correction direction to make the blur correction in the moving direction. The threshold TH is smaller than the blur correction swing angle α. The controller 15 sets the threshold TH in the direction opposite to the correction direction with respect to the reference position. Since the imaging device 11 performs imaging while the mirror 41 is being rotated through the blur correction swing angle α, the mirror 41 always passes through the reference position during imaging. Therefore, the accuracy of the blur correction can be improved.

Further, the mirror 41 as the blur corrector reflects the light L1 from the imaging target surface 9a to the imaging device 11. The blur correction assembly 31 includes the mirror drive 43 that rotationally drives the mirror 41. By using the mirror 41 as the blur corrector, the blur correction can be appropriately made.

The controller 15 causes the imaging device 11 to perform imaging every time the mirror 41 is located within the range where the amount of displacement from the reference position is less than or equal to the threshold TH. The imaging device 11 then consecutively acquires images in a line so that end regions in the respective moving directions in the captured images Im1 to Im3 overlap with end regions on the sides opposite to the moving directions in respective next captured images Im2 to Im4. This makes it possible to prevent imaging omission between captured images and acquire continuous captured images.

Further, the blur correction assembly 31 may include the imaging device drive assembly 32 that rotationally drives the imaging device 11A. The imaging device drive assembly 32 may rotationally move the imaging device 11A itself as the blur corrector. As a result, since the imaging device 11A can reliably perform imaging when the lens 23 is located at the reference position, the variations in the subject distance in the imaging plane is reduced, and the accuracy of the blur correction is improved. The blur correction is for setting the blur correction swing angle α as the blur correction amount depending on the subject distance.

A mirror rotation method for rotating the mirror 41 and a camera drive method for rotating the lens 23 and the imaging element 25 have been described. Theoretically, in both the methods, the subject distances in the imaging plane can be made uniform by changing the inclination of the mirror 41 as the blur corrector or the inclination of the lens 23 and the imaging element depending on the attitude of the vehicle 3. In the case of the mirror rotation method, as the inclination with respect to the imaging surface is closer to be parallel from 45 degrees, the reflection angle becomes an acute angle. Thus, the end of the mirror 41 enters the lens surface of the lens 23 on the optical path, and thus vignetting occurs. As the inclination with respect to the imaging surface is closer to be perpendicular from 45 degrees, the reflected light may deviate from the lens 23. In these cases, a desired range may not be imaged. In the camera drive method, such a state does not occur.

### Second Embodiment

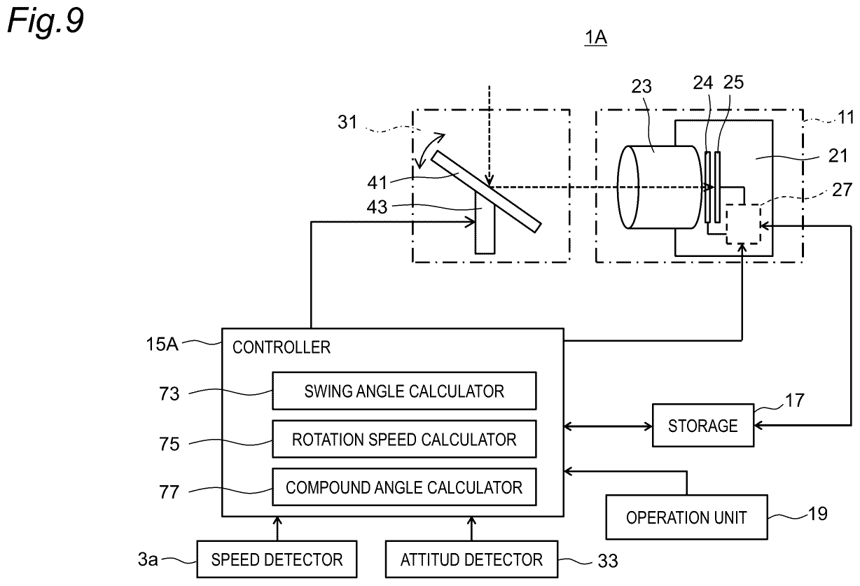

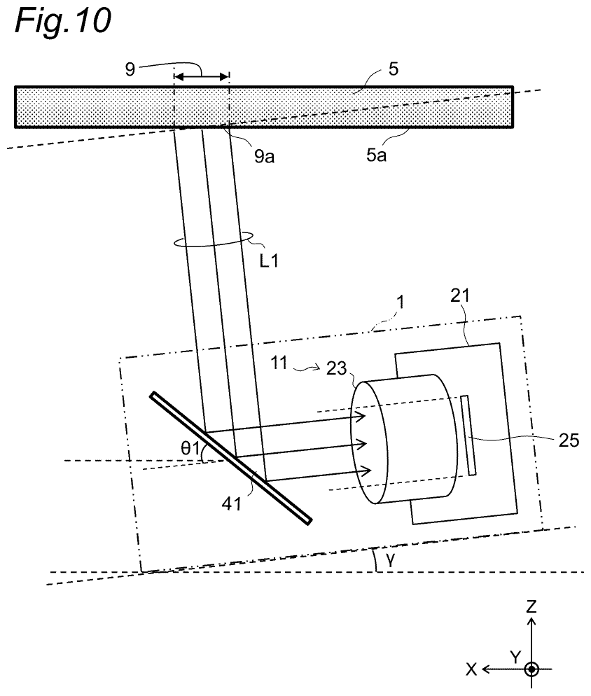

The imaging system 1A according to a second embodiment will be described with reference to FIGS. 9 to 10. FIG. 9 is a block diagram illustrating an internal configuration of the imaging system 1A according to the second embodiment. FIG. 10 is an explanatory diagram explaining the imaging system 1A at a time when the attitude of the vehicle 3 changes.

In the first embodiment, the imaging timing is adjusted to an appropriate range of the second mechanism swing angle β of the blur correction assembly 31. However, when the attitude of the vehicle 3 changes, even in this case, the axis perpendicular to the imaging target surface 9a is not parallel to the optical axis, and the subject distances in the imaging plane may vary. For example, as illustrated in FIG. 10, when the attitude of the vehicle 3 changes in the pitch direction, the subject distances of the light L1 vary even if the first mechanism swing angle θ1 is 45 degrees. This is because the entire imaging system 1 is inclined by an attitude change angle γ. The first mechanism swing angle θ1 is a mechanical angle of the mirror 41. The variations in subject distances are reduced by rotation in a direction opposite to a change direction of the attitude change angle γ by the mechanism swing angle corresponding to the attitude change angle γ of the entire imaging system 1. Therefore, in the second embodiment, the imaging timing is adjusted in response to the attitude change of the vehicle 3. For example, the controller 15A may correct the timing when the imaging device 11 starts imaging by correcting the rotation angle of the mirror 41 corresponding to the reference position based on the attitude change amount of the vehicle 3.

As illustrated in FIG. 9, the imaging system 1A according to the second embodiment has a configuration in which the imaging system 1 according to the first embodiment includes an attitude detector 33 and a compound angle calculator 77. The attitude detector 33 detects the attitude change amount of the imaging device 11. The points of the configuration other than the above-described point and points described below are common between the imaging system 1A according to the second embodiment and the imaging system 1 according to the first embodiment.

In the second embodiment, the imaging device 11 is integrated with the vehicle 3 and thus can be regarded as one rigid body. Therefore, the attitude change angle of the imaging device 11 is identical to the attitude change angle of the vehicle 3. The attitude detector 33 detects the attitude change amount of the imaging device 11 by detecting the attitude change angle γ (see FIG. 10) in the rotation direction where the blur correction assembly 31 makes a blur correction with respect to a reference attitude of the vehicle 3. The attitude detector 33 is, for example, a gyro sensor or an acceleration sensor. The detected attitude change angle γ is output to the controller 15A. In the second embodiment, the attitude detector 33 detects at least the attitude change angle γ of the vehicle 3 in the pitch direction with a horizontally maintained state being the reference attitude. The attitude detector 33 may detect an attitude change angle in a yaw direction or a roll direction in addition to the pitch direction.

The controller 15A includes the compound angle calculator 77 that calculates a compound angle ψ. The compound angle ψ is a sum of the attitude angle γ detected by the attitude detector 33 and kβ obtained by multiplying the second mechanism swing angle β by the conversion coefficient k. Here, the positive and negative directions of the attitude change angle γ and the positive and negative directions of the second mechanism swing angle β are set to respectively coincide with each other. The compound angle calculator 77 may not calculate the compound angle ψ when the blur correction assembly 31 is drives the mirror 41 in the direction opposite to the correction direction.

The controller 15A determines whether the compound angle γ is greater than or equal to 0 [deg], which is the reference position of the mirror 41, and smaller than or equal to the threshold TH. When determining that the compound angle γ is greater than or equal to or 0 and smaller than or equal to the threshold TH, the controller 15A transmits a Hi exposure control signal to the camera controller 27 to cause the imaging device 11 to perform imaging.

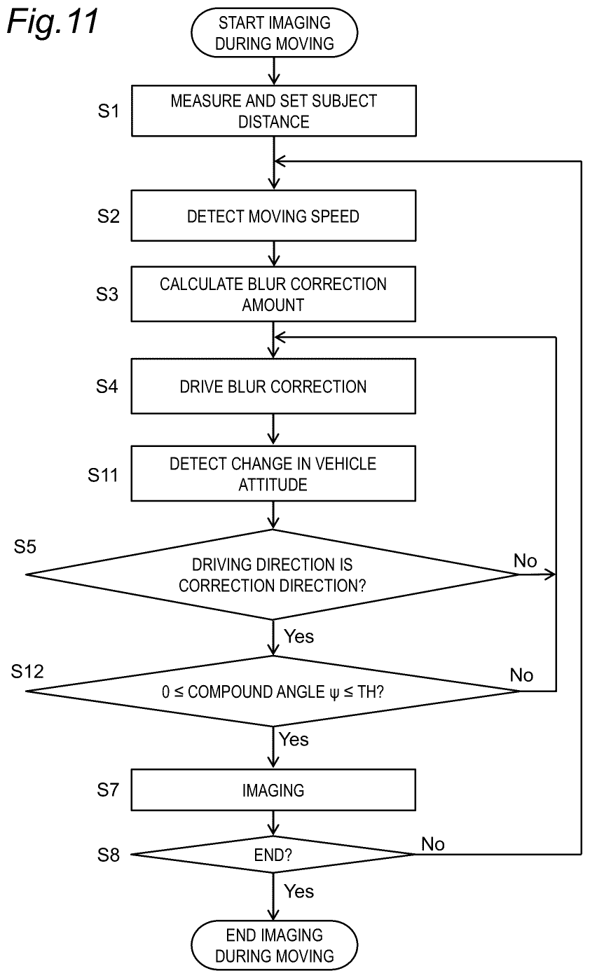

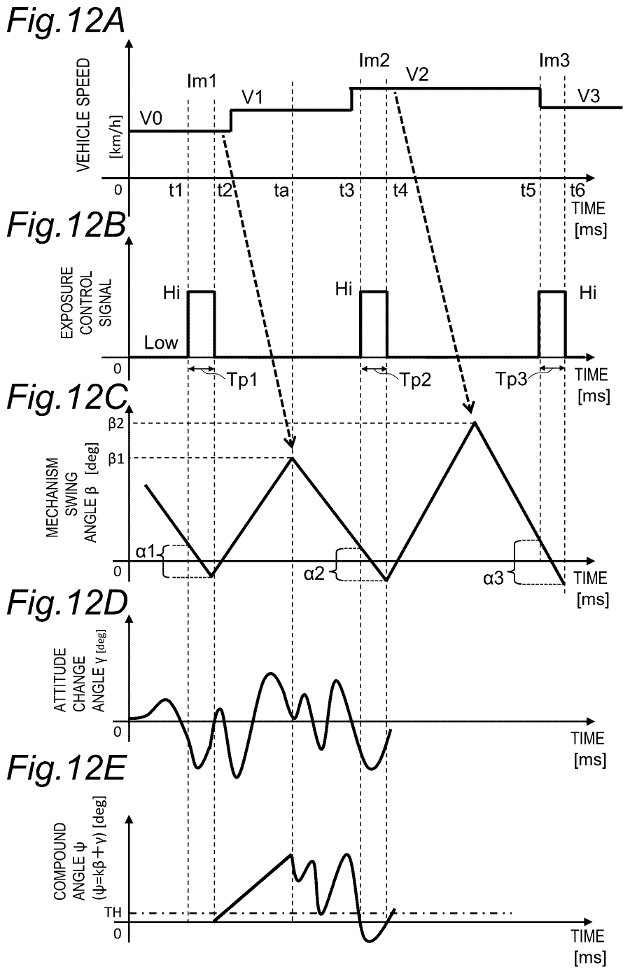

An operation of the imaging system 1A in the second embodiment will be described with reference to FIGS. 11 and 12. FIG. 11 is a flowchart illustrating imaging processing in the second embodiment. In the operation of the imaging system 1A in the second embodiment, step S11 is added to and step S6 is replaced by step S12 in the operation of the imaging system 1 in the first embodiment. FIG. 12A-12E are graphs illustrating a relationship between the second mechanism swing angle β of the blur correction assembly and exposure. FIG. 12A is the graph illustrating the moving speed of the vehicle 3. The moving speed changes with the lapse of time. FIG. 12B is the graph illustrating the timing of the exposure time. FIG. 12C is the graph illustrating variations in the second mechanism swing angle β of the blur correction assembly. FIG. 12D is the graph illustrating variations in the attitude change angle γ detected by the attitude detector 33, and illustrates a graph up to the exposure of the second image Im2. FIG. 12E is the graph illustrating variations in the compound angle ψ, and illustrates the graph from the exposure of the first image Im2 to the exposure of the second image Im2.

Steps S1 to S5, S7, and S8 are similar to the operation of the imaging system 1 in the first embodiment, and thus description thereof is omitted. In step S4, the blur correction drive is performed. After the mirror drive 43 displaces the mirror 41 to the rotation start position β31 without considering the attitude change of the vehicle 3 between time t2 and time ta, the attitude detector 33 detects the attitude change angle γ of the vehicle 3 in step S11. The positive direction of the attitude change angle γ is the same as the positive rotation direction of the second mechanism swing angle β. The detected attitude change angle γ is sent to the controller 15, and the compound angle calculator 77 calculates a compound angle ψ(=k×β+γ). The compound angle is obtained by adding the attitude change angle γ to k×β obtained by multiplying the second mechanism swing angle β by the conversion coefficient k. The compound angle ψ can also be said to be a correction position with respect to the imaging target surface 9a.

In step S12, the controller 15 determines whether the compound angle ψ is smaller than or equal to the threshold TH. The threshold TH is greater than 0 degrees. That is, the controller 15 determines whether the following Equation (8) is satisfied.

$$0 \leq ψ \leq TH \qquad Equation ( 8 )$$

When determining that the compound angle ψ is not smaller than or equal to the threshold TH (No in step S12), the controller 15 continues step S4. When determining that the compound angle ψ is greater than or equal to 0 and smaller than or equal to the threshold TH (Yes in step S12), the controller 15 continues sending a Hi signal instructing exposure to the camera controller 27 during the exposure time Tp and performs imaging in step S7.

By starting imaging when the compound angle ψ is greater than or equal to 0 and smaller than or equal to the threshold TH, imaging can be performed at a timing of offsetting the attitude change of the vehicle 3 and kβ obtained by converting the second mechanism swing angle β of the mirror 41 into the optical angle. Therefore, imaging can be performed when the change in the subject distance due to the attitude change of the vehicle 3 is small, and degradation in the accuracy of the blur correction can be suppressed.

In the case of the camera drive method, the inclination of the lens 23 and the imaging element 25 has to be changed by the angle identical to the angle of the inclination in order to offset the inclination. However, in the mirror method, the inclination can be offset by inclining in the opposite direction by the half of the camera inclination (optical angle). Therefore, the angle for offsetting the vehicle attitude change may be half the vehicle attitude change angle. Therefore, the mirror method is more excellent in responsiveness.

In such a way, the imaging system 1A includes the attitude detector 33 that detects the attitude change angle γ of the vehicle 3, and the controller 15A corrects the position of the mirror 41 corresponding to the reference position based on the attitude change angle γ, thereby correcting the timing when the imaging device 11 starts imaging. When the attitude of the vehicle 3 changes in the pitch direction, the rotation position of the mirror 41 varies depending on the attitude of the vehicle 3. The rotation position corresponds to the reference position where the axis perpendicular to the imaging target surface 9a is parallel to the optical axis of the light injected to the mirror 41. In such a state, the controller 15A makes a correction based on the attitude change angle γ using a position where the compound angle ψ becomes 0 as the reference position. The compound angle ψ is obtained by correcting the second mechanism swing angle β of the mirror 41, and corresponds to the reference position. The controller 15A corrects the timing of causing the imaging device 11 to start imaging, based on the timing when the compound angle ψ becomes 0. This makes it possible to reduce the influence of the attitude change of the vehicle 3 on the subject distance and to suppress the degradation in the accuracy of the blur correction.

In addition, the controller 15A causes the imaging device 11 to start imaging at the timing when the compound angle ψ as the correction position becomes smaller than or equal to the threshold TH with respect to the reference position. The correction position is calculated based on the attitude change angle γ and the second mechanism swing angle β during the blur correction operation of the mirror 41 This makes it possible to reduce the influence of the attitude change of the vehicle 3 on the subject distance and to suppress the degradation in the accuracy of the blur correction.

### Other Embodiments

The above embodiments have been described as the examples of the technique disclosed in this application. However, the technique in the present disclosure is not limited to them, and is applicable to embodiments in which changes, replacements, additions, omissions, etc. are made as appropriate. Therefore, other embodiments will be exemplified below.

In the above embodiment, the imaging device 11 and the blur correction assembly 31 are separate from each other, but the present disclosure is not limited thereto. The imaging device 11 may have a configuration where the camera body 21, the lens 23, and an optical axis changing mechanism instead of the blur correction assembly 31 are integrated. The imaging device 11 may have, for example, a tilt function of rotating the camera body 21 and the lens 23 in the vertical direction and a pan function of rotating them in the horizontal direction. Instead of the blur correction assembly 31, a mechanism that rotates the entire imaging device 11 in two orthogonal directions may be provided. The blur correction assembly 31 may be configured by two mirrors and motors. Their rotation axes are orthogonal to each other.

In the above embodiments, the information about the moving speed V1 from the speed detector 3a of the vehicle 3 is used, but the present disclosure is not limited thereto. The imaging system 1 may include a speed detector that detects the moving speed of the imaging system 1. The speed detector may use a GPS.

In the above embodiments, the imaging system 1 images wall surfaces above and beside the vehicle 3, but the present disclosure is not limited thereto. The imaging system 1 may image a road surface below the vehicle 3. A pot hole, a crack, a rut, or the like that occurs on the road surface can be detected in a captured image with image processing.

The above embodiments have described the case where the mobile object is the vehicle 3 such as an automobile. However, the mobile object is not limited to the vehicle 3, and may be a vehicle traveling on the ground such as a train or a motorcycle, a ship traveling on the sea, or a flying object such as an airplane or a drone flying in the air. In a case where the mobile object is a ship, the imaging system 1 images a bottom surface of a bridge pier or bridge girder, or a structure constructed along a coast. In a case where the mobile object is a train, the position and wear of wiring can be detected by imaging the wiring.

In the above embodiments, the image is captured by the light which is ambient light reflected by the imaging target region 9, but the present disclosure is not limited thereto. The imaging target region 9 may be irradiated with light from the mobile object or the imaging system, and an image by reflected light of the irradiated light may be captured.

### Outline of Embodiments

(1) An imaging system of the present disclosure includes an imaging device disposed in a mobile object, a blur correction assembly that corrects, based on a blur correction amount, a blur in a moving direction where the mobile object moves at a time when the imaging device performs imaging while the mobile object is moving, and a controller that controls an imaging timing of the imaging device. The blur correction assembly drives the blur corrector to make a blur correction in the moving direction. The blur corrector has the reference position where the axis perpendicular to the imaging target surface is parallel to the optical axis of light injecting to the blur corrector. The controller causes the imaging device to start imaging in synchronization with a time when the blur corrector is located within the range where the amount of displacement from the reference position is smaller than or equal to a threshold during driving of the blur corrector.

As a result, the imaging device can reliably perform imaging when the blur corrector is located at the reference position. This makes it possible to reduce variations in the subject distance between the imaging device and the imaging target surface, reduce a blur of a captured image, and acquire an image captured during an appropriate exposure time.

(2) In the imaging system in (1), the blur corrector is driven by an amount greater than the blur correction amount for making the blur correction in the moving direction.

(3) In the imaging system in (1) or (2), the controller updates the threshold based on the blur correction amount of the imaging device.

(4) In the imaging system in any one of (1) to (3), the controller causes the imaging device to start imaging when the blur corrector is located at the reference position or before the blur corrector reaches the reference position, and ends the imaging after the blur corrector passes through the reference position.

(5) In the imaging system in (1) to (4), the blur correction assembly rotates the blur corrector in the correction direction to make the blur correction in the moving direction, the threshold is smaller than the blur correction amount, and the controller sets the threshold in the direction opposite to the correction direction with respect to the reference position.

(6) In the imaging system in (5), the blur correction assembly reverses a driving direction of the blur corrector to the direction opposite to the correction direction based on an imaging end timing.

(7) The imaging system in any one of (1) to (6), further includes an attitude detector that detects an attitude change amount of the mobile object, the controller corrects a position of the blur corrector corresponding to the reference position based on the attitude change amount to correct a timing when the imaging device starts imaging.

(8) The imaging system in any one of (1) to (6), further includes an attitude detector that detects an attitude change amount of the mobile object, the controller causes the imaging device to start imaging at a timing when a correction position calculated based on the attitude change amount and a position of the blur corrector that is performing a blur correction operation is less than or equal to the threshold with respect to the reference position.

(9) In the imaging system in any one of (1) to (8), the blur corrector is the imaging device, and the blur correction assembly includes an imaging device drive assembly that rotationally drives the imaging device.

(10) In the imaging system in any one of (1) to (8), the blur corrector is a mirror that reflects light from the imaging target surface to the imaging device, and the blur correction assembly includes a mirror drive assembly that rotationally drives the mirror.

(11) In the imaging system in any one of (1) to (10), the blur correction assembly rotates the blur corrector in a correction direction for making the blur correction in the moving direction, and the blur correction amount is a rotation amount for rotating the blur corrector in the correction direction, the rotation amount corresponding to a movement amount of a pixel on an imaging element of the imaging device due to a movement of the mobile object.

(12) In the imaging system in any one of (1) to (11), the controller causes the imaging device to perform imaging every time the blur corrector is located within a range where the amount of displacement from the reference position is smaller than or equal to a threshold, and consecutively acquires images in a line so that an end region in the moving direction in a captured image among the acquired images overlap with an end region on a side opposite to the moving direction in a next image among the acquired images.

(13) In the imaging system in any one of (1) to (12), the controller increases the threshold as a moving speed of the mobile object becomes higher, and decreases the threshold as the moving speed of the mobile object becomes lower.

(14) The imaging system in any one of (1) to (13) further includes a speed detector that detects a moving speed of the mobile object, and the controller calculates the blur correction amount based on the detected moving speed.

(15) A mobile object of the present disclosure includes the imaging system in any one of (1) to (14). This makes it possible for the imaging system to reduce a blur and to capture an image of a periphery of the mobile object while the mobile object is moving.

The present disclosure is applicable to an imaging system installed in a moving mobile object.

### EXPLANATIONS OF LETTERS OR NUMERALS

1, 1A Imaging system
3 Vehicle
3a Speed detector
5 Tunnel
5a Wall surface
5b Hole
5c Crack
9 Imaging target region
11 Imaging device
15 Controller
17 Storage
19 Operation unit
21 Camera body
23 Lens
24 Shutter
25 Imaging element
26 Lens barrel
27 Camera controller
28a, 28b Rotation axis
31 Blur correction assembly
32 Imaging device drive assembly
32a Arm
32b Base
33 Attitude detector
41 Mirror
43 Mirror drive
73 Swing angle calculator
75 Rotation speed calculator
77 Compound angle calculator
α Blur correction swing angle
β Second mechanism swing angle
β1, 2 Rotation start position
θ Blur correction angle
θ1 First mechanism swing angle
F Focal length
L Movement amount of vehicle
L1 Light
M Subject magnification
P Movement amount of pixel
Tp Exposure time
t1, t2, t3, t4, t5, t6 Time
V, V0, V1, V2, V3 Moving speed
Vm Rotation speed

What is claimed is:

1. An imaging system comprising:
an imaging device disposed in a mobile object;
a blur correction assembly that corrects, based on a blur correction amount, a blur along a moving direction of the mobile object in a captured image by the imaging device while the mobile object is moving; and
a controller that controls an imaging timing of the imaging device,
wherein the blur correction assembly drives a blur corrector to make a blur correction along the moving direction,
the blur corrector has a drive range including a reference position where an axis perpendicular to an imaging target surface is parallel to an optical axis of the imaging device, the optical axis being an axis of light injecting to the blur corrector from the imaging target surface, and
the controller causes the imaging device to start imaging when the blur corrector is located within a range where a difference from the reference position is less than or equal to a threshold during driving of the blur corrector.

2. The imaging system according to claim 1,
wherein the blur corrector is driven by an amount greater than the blur correction amount for making the blur correction in the moving direction.

3. The imaging system according to claim 1,
wherein the controller updates the threshold based on the blur correction amount of the imaging device.

4. The imaging system according to claim 1,
wherein the controller causes the imaging device to start imaging when the blur corrector is located at the reference position or before the blur corrector reaches the reference position, and ends the imaging after the blur corrector passes through the reference position.

5. The imaging system according to claim 1,
wherein the blur correction assembly rotates the blur corrector in a correction direction to make the blur correction in the moving direction, and
the threshold is smaller than the blur correction amount, and
the controller sets the threshold in a direction opposite to the correction direction with respect to the reference position.

6. The imaging system according to claim 5,
wherein the blur correction assembly reverses a driving direction of the blur corrector to the direction opposite to the correction direction based on an imaging end timing.

7. The imaging system according to claim 1, further comprising
an attitude detector that detects an attitude change amount of the mobile object,
wherein the controller corrects a position of the blur corrector corresponding to the reference position based on the attitude change amount to correct a timing when the imaging device starts imaging.

8. The imaging system according to claim 1, further comprising:
an attitude detector that detects an attitude change amount of the mobile object,
wherein the controller causes the imaging device to start imaging at a timing when a correction position calculated based on the attitude change amount and a position of the blur corrector that is performing a blur correction operation is less than or equal to the threshold with respect to the reference position.

9. The imaging system according to claim 1,
wherein the blur corrector is the imaging device, and
the blur correction assembly includes an imaging device drive assembly that rotationally drives the imaging device.

10. The imaging system according to claim 1,
wherein the blur corrector is a mirror that reflects light from the imaging target surface to the imaging device, and
the blur correction assembly includes a mirror drive assembly that rotationally drives the mirror.

11. The imaging system according to claim 1,
wherein the blur correction assembly rotates the blur corrector in a correction direction for making the blur correction in the moving direction, and
the blur correction amount is a rotation amount for rotating the blur corrector in the correction direction, the rotation amount corresponding to a movement amount of a pixel on an imaging element of the imaging device due to a movement of the mobile object.

12. The imaging system according to claim 1,
wherein the controller causes the imaging device to perform imaging every time the blur corrector is located within a range where the amount of displacement from the reference position is smaller than or equal to the threshold, and continuously acquires images in a line so that an end region in the moving direction in the captured image among the acquired images overlap with an end region on a side opposite to the moving direction in a next image among the acquired images.

13. The imaging system according to claim 1,
wherein the controller increases the threshold as a moving speed of the mobile object becomes higher, and decreases the threshold as the moving speed of the mobile object becomes lower.

14. The imaging system according to claim 1, further comprising
a speed detector that detects a moving speed of the mobile object,
wherein the controller calculates the blur correction amount based on the detected moving speed.

15. The imaging system according to claim 1,
wherein the reference position is a position where the blur corrector is inclined with respect to an imaging surface of the imaging device so that the axis perpendicular to the imaging target surface is parallel to the optical axis of the imaging device, the optical axis being the axis of light injecting to the blur corrector from the imaging target surface, and
the controller causes the imaging device to start imaging when an angular difference between the blur corrector and the reference position becomes smaller than or equal to the threshold during driving of the blur corrector.

16. A mobile object comprising the imaging system according to claim 1.

17. The imaging system according to claim 2,
wherein the controller updates the threshold based on the blur correction amount of the imaging device.

18. The imaging system according to claim 17,
wherein the controller causes the imaging device to start imaging when the blur corrector is located at the reference position or before the blur corrector reaches the reference position, and ends the imaging after the blur corrector passes through the reference position.

19. The imaging system according to claim 17,
wherein the blur correction assembly rotates the blur corrector in a correction direction to make the blur correction in the moving direction, and
the threshold is smaller than the blur correction amount, and
the controller sets the threshold in a direction opposite to the correction direction with respect to the reference position.

20. An imaging system comprising:
an imaging device disposed in a mobile object;
a blur correction assembly that corrects, based on a blur correction amount, a blur along a moving direction of the mobile object in a captured image by the imaging device while the mobile object is moving; and
a controller that controls an imaging timing of the imaging device,
wherein the blur correction assembly rotates the imaging device to make a blur correction along the moving direction,
the imaging device has a rotate range including a reference position where an axis perpendicular to an imaging target surface is parallel to an optical axis of light injecting to the imaging device, and
the controller causes the imaging device to start imaging when the imaging device is located within a range where a difference from the reference position is less than or equal to a threshold during rotating of the imaging device.
